(19) United States
(12) Patent Application Publication
(10) Pub. No.: US 2009/0066058 A1
(43) Pub. Date: Mar. 12, 2009

(54) Trailer mounted boat guiding system

(76) Inventor: Melvin Andrew Comried, JR., Cypress, CA (US)

Correspondence Address: LAW OFFICES OF LARRY K. ROBERTS, INC., 2 Park Plaza, Suite 300, Irvine, CA, 92614, US

(21) Appl. No.: 11/900,300

(22) Filed: Sep. 10, 2007

(51) Int. Cl. B60P 3/10

(52) U.S. Cl. 280/414.1

(57) ABSTRACT

An exemplary embodiment of a boat bow guide system includes a cross-bracket structure adapted for mounting to a boat trailer at a bow location on the trailer, the cross-bracket structure having opposed first and second arm mounting portions. First and second arm support members are adapted for telescopic mounting to respective ones of the first and second arm mounting portions, so that each of the first and second arm support members may be fixed in position at a plurality of positions between an inward position and an outward position. Boat guiding arms may be mounted to the arm support members for guiding the bow of the boat during launching and recovery operations.

### BACKGROUND

Boats and water craft may be moved between a land-based storage site and a lake, river, ocean, bay or marina by a trailer. The user typically pulls the trailer behind a vehicle such as a car or truck on a roadway, backs up the trailer to a launch site, and launches the boat from the trailer onto the water. To recover the boat from the water, the user backs up the trailer into the water at the launch site, and drives or pulls the boat onto the trailer. Whether launching or recovering a boat, currents, waves or wind may make the boat more difficult to control.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic view illustrating an exemplary embodiment of a boat on a trailer being launched or recovered from the water.

FIG. 2 is a diagrammatic isometric view illustrating an exemplary embodiment of a long tongue boat trailer with a boat bow guide system.

FIG. 3 is a diagrammatic isometric view of an exemplary embodiment of a cross bracket structure of a boat bow guide system.

FIG. 4 is a diagrammatic isometric view of a fragment of the cross bracket structure of FIG. 3, with an exemplary embodiment of an angle bracket for support a guide arm structure.

FIG. 5 illustrates an exemplary embodiment of a guide arm structure.

FIG. 6 is a diagrammatic isometric view showing an exemplary A frame boat trailer and aspects of an exemplary embodiment of a boat bow guide system.

FIG. 7 illustrates fragments of an exemplary angle bracket and cross bracket structure of the bow guide system of FIG. 6. FIG. 8 further illustrates a fragment of the angle bracket of FIGS. 6 and 7.

### DETAILED DESCRIPTION

In the following detailed description and in the several figures of the drawing, like elements are identified with like reference numerals. The figures are not to scale, and relative feature sizes may be exaggerated for illustrative purposes.

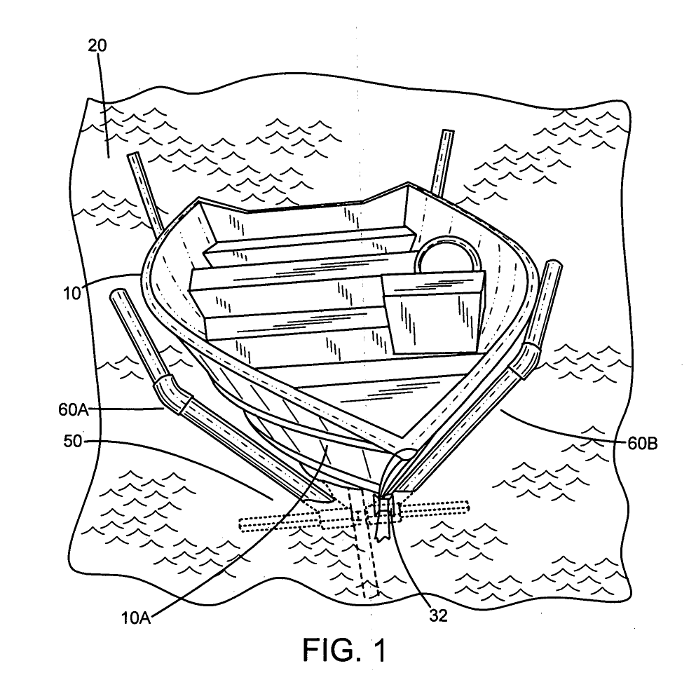

FIG. 1 diagrammatically illustrates a boat 10 being launched from or recovered to a trailer, which has been backed into the water 20 in a launch site so that the trailer wheels are submerged and not visible in FIG. 1. Mounted to the boat trailer is an exemplary embodiment of a bow guide system 50. The bow guide system includes guide arms 60A, 60B which guide the port and starboard sides of the bow region 10A of the boat into or out of the trailer in a controlled fashion, facilitating launching into or recovering the boat from the water.

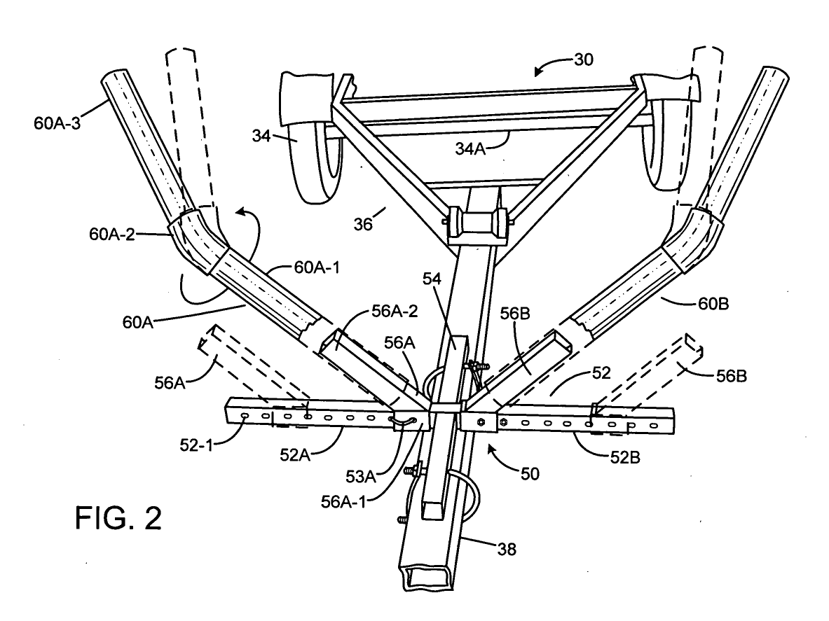

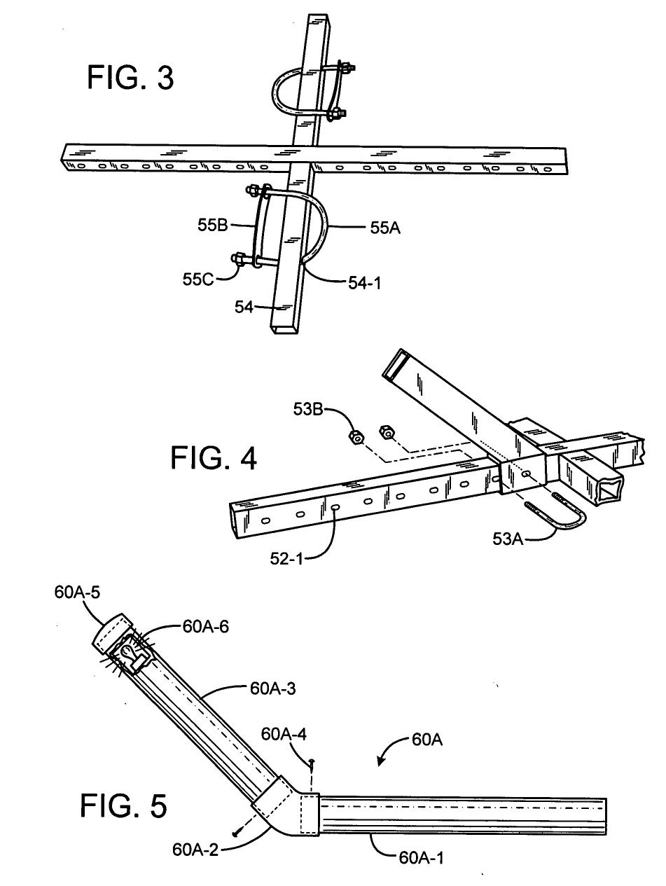

The exemplary bow guide system 50 is further illustrated in FIGS. 2-5. This exemplary embodiment is adapted for attachment to a long tongue boat trailer, depicted as trailer 30. The trailer wheels 34 are mounted on an axle 34A, which is supported by the rear axle frame 36. The center tongue 38 of the trailer extends from the trailer rear axle frame 36 forward to the front end of the trailer, which typically has a trailer coupling (not shown in FIG. 2) for attachment to a vehicle which will pull the trailer. The trailer tongue may be a steel hollow tube or a beam, for example.

The exemplary system 50 includes a cross bracket member 52 which is mounted transverse to the tongue 38, and includes cross bracket arm portions 52A and 52B which extend out from the tongue on either side. The cross bracket arm portions include a series of spaced holes 52-1, which are used to secure angle brackets 56A and 56B at selected positions along the extents of the cross bracket portions 52A and 52B. The holes may be circular or slot or oblong shaped, for example. The cross bracket member 52 may be fabricated of a rectangular or square metal tube, e.g. a steel tube. The dimensions of the bracket member may depend on the requirements of the particular application, including the boat size.

Each angle bracket 56A and 56B includes a bracket attachment portion and an angle portion which extends at an angle with respect to the attachment portion. In the example depicted in FIG. 2, the angle portion extends at an acute angle with respect to the attachment portion. In another example, the angle portion may extend at a 90 degree or even larger angle with respect to the attachment portion. For example, angle bracket 56A includes bracket attachment portion 56A-1 and angle portion 56A-2. The angle brackets may be fabricated of a hollow rectangular or square metal tube, e.g. a steel tube. The dimensions of the bracket attachment portion are preferably selected so that the attachment portion may be slide onto and over the cross bracket portion 52A or 52B in a telescoping arrangement. In one example, the attachment portion may have a square tube dimension of 1.5 inch, and the cross bracket arm portion may have a square tube dimension of 1.25 inch. Of course, the dimensions of the brackets may be varied, e.g., depending on the size and weight of the boat to be trailered. For example, a guide system for a 27 foot boat may employ 2 inch and 2.25 inch tube sizes, for the attachment portion and the cross bracket arm portions, respectively.

The telescopic arrangement of the angle brackets and the cross bracket portions allows the guide system 50 to be adjusted so that the width dimension between the angle brackets can be adjusted, and fixed to an adjusted position. This allows the guide system to be adapted to boats of different sizes.

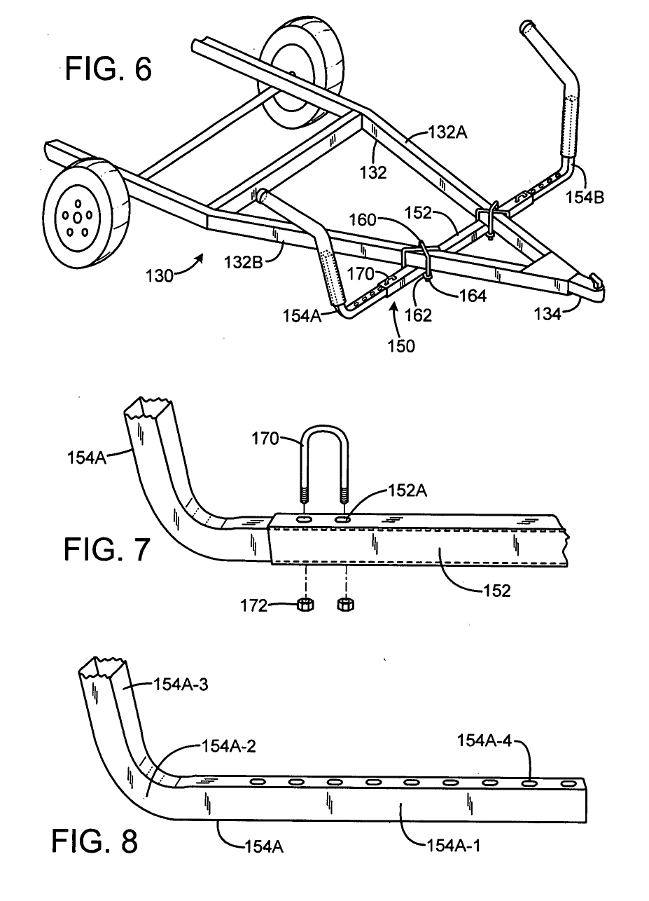

In another embodiment, the angle bracket may have an attachment portion which has a cross-sectional dimension which is smaller than the cross bracket portion, so that the attachment portion fits into the cross bracket portion. In this alternate embodiment, for example, the embodiment illustrated in FIGS. 6-8, the angle portion of the angle bracket is attached to an end of the attachment portion protruding from the cross bracket portion.

The size and shape of the angle brackets 56A and 56B may be varied to accommodate boats of differing sizes and hull shapes. The exemplary embodiment illustrated in FIGS. 2-5 may be adapted for handling boats with V-shaped hulls. The angle portion of the angle bracket may extend in a direction which is perpendicular to the trailer tongue, or at an acute angle with respect to the trailer tongue. For example, the angle portion may be swept back relative to the tongue for some applications.

The cross bracket member 52 may be attached to the trailer tongue 38 by various means. In this exemplary embodiment, a bracket attach structure 54 is a beam or tube section, which is connected to the cross bracket member in a transverse relationship, forming an “x” or cross shape in this example. The bracket attach structure 54 may be attached to the cross bracket member 52 by welding, for example. The structure 54 may be fabricated to form a unitary structure with the cross bracket member 52. The bracket attach structure 54 may be attached to the trailer tongue with U shaped fasteners 55A, attach strips 55B and threaded fasteners 55C. This attachment technique allows the user to adjust the position of the bow guide system 50 along the length of the tongue 38, to accommodate different boat sizes, for example. The bracket attach structure 54 may also be welded to the tongue in a more permanent arrangement, or attached by bolts passed through holes in the tongue.

In an exemplary embodiment, the bow guide system 50 further includes guide arms 60A and 60B, which mount onto the angle brackets 54A, 56B. The guide arms are supported by the angle brackets, so that the boat hull may contact the guide arms during boat recovery and boat launching to maintain the hull in a generally centered orientation relative to the boat trailer. The lateral spacing between the guide arms may be adjusted so that there is a relatively snug fit of the boat bow between the guide arms, and this can assist in securing the boat in position on the trailer while traveling. For example, when traveling on rough rods, the guide arms can assist in keeping the bow of the boat from bouncing around.

For this example, the guide arms 60A, 60B may be fabricated of PVC tubing, of a large enough diameter to fit onto the angle portions, yet be snug enough to be frictionally held in position. The guide arms may be fabricated in two sections, joined by an angle member, to allow angular rotation of a distal arm section relative to a section mounted on the angle bracket. Thus, as shown in FIGS. 2 and 5, guide arm 60A, for example, may include PVC tube section 60A1 mounted onto the bracket angle portion 56A, and a distal PVC section 60A3 coupled to section 60A1 by a PVC angle coupler 60A2. Threaded fasteners 60A4 may be used to secure the sections together. The angle coupler may allow rotation of the distal section 60A3 about the longitudinal axis of the section 60A1, with a sliding fit between the section 60A1 and the coupler 60A2. The guide arms may be fabricated of PVC tubing with a 2 inch inner diameter, to fit over angle portions with a 1.5 inch outer dimension.

The cross bracket member 52 provides a rigid structure connecting the guide arm support structures, which in an exemplary embodiment include the angle brackets 54A, 54B. The rigid connection structure imparts strength and rigidity to the guide arms, so that the arms are not knocked out of position due to hard contact with the boat bow, which might otherwise prevent the boat from centering properly during boat recovery operations, for example. Out of place guide arms could damage the boat or waste time in trying to launch or recover the boat.

In some embodiments, a light kit may be installed on the guide arms. FIG. 5 depicts an exemplary light kit 60A-6 mounted inside the guide arm section 60A-3. The guide arm section may be fabricated of a transparent or translucent material to pass light from the light kit. The light kit may be an incandescent or LED light source, powered by a low voltage source connected by wires to a power source, or by a battery pack.

FIGS. 6-8 illustrate an alternate embodiment of a bow guide system 150, adapted for attachment to and use with an A-frame boat trailer 130. This type of trailer generally has a frame with side rails 132A, 132B which meet at or adjacent the front of the trailer, near a trailer hitch location 134. The system 150 includes a cross bracket member 152, which may be mounted to the boat frame side rails 132A, 132B by U bolts 160, straps 162 and nuts 164 as generally depicted in FIG. 6. In an exemplary embodiment the cross bracket member is a rectangular or square tube member, e.g., fabricated of a metal such as steel or aluminum. The system further includes angle arm members 154A, 154B, which each include a bracket attach portion for telescopically engaging an end portion of the cross bracket member, and an arm portion generally directed in an upward or angled fashion from an elbow portion.

FIGS. 7-8 illustrate exemplary angle arm member 154 and its telescopic attachment to the cross bracket member 152. The cross bracket member has a pair of holes 152A formed in its upper and lower surfaces. The angle arm member includes a bracket attach portion 154A-1, an elbow portion 154A-2 and an arm portion 154A-3. The bracket attach portion of the angle arm member has a series of spaced holes 154A-4 formed through its upper and lower surfaces, and can be inserted into the hollow cross bracket member to a desired depth to set the spacing of the arm portion from the center of the trailer. With holes in the bracket attach portion lined up with the holes 152A in the cross bracket member, a U bolt 170 can be inserted through the holes formed in both telescopic members, and secured with nuts 172.

The arm portions of the angle arm members 154A, 154B can be long enough to provide contact with the bow of the boat in some applications. However, it is contemplated that, for an exemplary embodiment, the angle arm members may be fabricated from a tube steel or metal stock, and bent with a tube bender or like tooling to assume the shape shown in FIG. 8. In this example, the angle arm portion may be covered with a softer material to prevent scratching or dinging the boat bow. Alternatively, the angle arm portions may be used to attach PVC guide arm sections, as depicted with the embodiment of FIG. 1. In this case, the guide arm sections may be slightly oversized relative to the angle arm portions to provide an sliding or interference fit.

Exemplary embodiments of the bow guide system are readily attached to a boat trailer. The cross bracket structure may be positioned on the tongue or side rails of the trailer, attached in position, and the width of the guide arms adjusted for a snug fit of the bow. The brackets for the guide arms may be secured in the selected positions.

A boat may be recovered onto a trailer by driving or in some instances pulling the boat toward the trailer while in the water. The bow of the boat is centered by allowing it to softly “bounce” off the guide arms, keeping it centered while the boat bow reaches the front of the trailer. The guide arms may be angled to follow the lines of the boat, e.g., as depicted in the exemplary embodiment of FIG. 1. The boat may be secured to the trailer using a cable hooked to the boat eyelet, and winched into place against the trailer bow guide roller 32 (FIG. 1) in the typical manner.

Although the foregoing has been a description and illustration of specific embodiments of the subject matter, various modifications and changes thereto can be made by persons skilled in the art without departing from the scope and spirit of the invention as defined by the following claims.

What is claimed is:

1. A trailer-mountable boat bow guiding system, comprising:
a cross-bracket structure adapted for mounting to a boat trailer at a bow location on the trailer, the cross-bracket structure having opposed first and second arm mounting portions;
first and second arm support members adapted for telescopic mounting to respective ones of the first and second arm mounting portions, so that each of the first and second arm support members may be fixed in position at a plurality of positions between an inward position and an outward position, so that a spacing distance between said first and second arm support members may be adjusted between a minimum spacing distance and a maximum spacing distance in a range of mounting positions; and
first and second rigid bow guiding arms mounted respectively to the first and second arm support members for guiding the bow of the boat at respective port and starboard sides of the boat bow.

2. The system of claim 1, wherein the arm mounting portions respectively comprise first and second hollow tubular member portions each having a set of holes formed therein in spaced apart relation.

3. The system of claim 2, wherein the first and second bow guiding arms comprise third and fourth hollow tubular member portions each having a set of holes formed therein in spaced apart relation.

4. The system of claim 3, further comprising first and second fastener members adapted to secure the first and second hollow tubular member portions to said third and fourth hollow tubular member portions at selected mounting positions in said range.

5. The system of claim 1, further comprising attachment fasteners for attaching the cross bracket structure to a frame structure of the boat trailer.

6. The system of claim 5, wherein the boat trailer has an A frame with left and right frame side rails, and the attachment fasteners are adapted to secure the cross bracket structure to said left and right frame side rails.

7. The system of claim 5, wherein the trailer has a long center tongue rail, the cross bracket structure has a bracket attach structure, and the attachment fasteners are adapted to secure the bracket attach structure to the center tongue rail so that the opposed first and second arm mounting portions extend in generally perpendicular directions relative to the center tongue rail.

8. The system of claim 1, wherein the first and second bow guiding arms each comprise a first rigid section and a second rigid section coupled together by an elbow coupler permitting rotation of the elbow and second rigid section about the first rigid section.

9. The system of claim 8, wherein the first rigid section and the second rigid section are fabricated from a hollow plastic tubing material.

10. A boat bow guiding system for a boat trailer, comprising:
a cross bracket structure mounted to a boat trailer at a bow location on the trailer, the cross-bracket structure having opposed first and second arm mounting portions;
first and second arm members adapted for telescopic mounting to respective ones of the first and second arm mounting portions, so that each of the first and second arm members may be fixed in position at a plurality of positions between an inward position and an outward position, so that a spacing distance between said first and second arm members may be adjusted between a minimum spacing distance and a maximum spacing distance in a range of mounting positions, the first and second arm members comprising guide arm portions disposed in a generally upwardly direction for guiding a bow region of a boat on port and starboard sides of the boat.

11. The system of claim 10, wherein the arm mounting portions respectively comprise first and second hollow tubular member portions each having a first set of holes formed therein in spaced apart relation.

12. The system of claim 11, wherein the first and second arm members comprise third and fourth hollow tubular member portions each having a second set of holes formed therein in spaced apart relation, the third and fourth hollow tubular members having an inner dimension larger than an outer dimension of the first and second hollow tubular member portions so as to fit over said first and second hollow tubular member portions in a telescoping arrangement.

13. The system of claim 12, further comprising first and second fastener members adapted to pass through overlapping ones of said first and second sets holes to secure the first and second hollow tubular member portions to said third and fourth hollow tubular member portions at selected mounting positions in said range.

14. The system of claim 10, wherein the boat trailer has an A frame with left and right frame side rails, and the cross bracket structure is secured to said left and right frame side rails.

15. The system of claim 10, wherein the trailer has a long center tongue rail, the cross bracket structure includes a bracket attach structure extending along the center tongue rail, and the bracket attach structure is secured to the center tongue rail.

16. The system of claim 10, further comprising a guide arm tube structure mounted on each arm member.

17. The system of claim 16, wherein said guide arm tube structure includes a first rigid section and a second rigid section coupled together by an elbow coupler permitting rotation of the elbow and second rigid section about the first rigid section.

18. The system of claim 17, wherein the first rigid section and the second rigid section are fabricated from a hollow plastic tubing material.

19. The system of claim 10, further comprising an electrically powered light module carried by one of said guide arms.

20. The system of claim 10, wherein the cross bracket structure provides a rigid one-piece connection structure supporting the first and second arm members.
